(19) United States
(12) Patent Application Publication
(10) Pub. No.: US 2018/0236813 A1
(43) Pub. Date: Aug. 23, 2018

(54) DRIVING DEVICE FOR CARRIAGE

(71) Applicant: NABTESCO CORPORATION, Tokyo (JP)

(72) Inventors: Osamu OCHIAI, Tsu-shi (JP); Takashi NARUSE, Tsu-shi (JP); Kenya TOMIYASU, Tsu-shi (JP)

(21) Appl. No.: 15/896,368

(22) Filed: Feb. 14, 2018

(30) Foreign Application Priority Data
Feb. 20, 2017 (JP) 2017-029267

(51) Int. Cl. B60B 11/02; B60B 19/00; B60B 19/12; B60B 33/00

(52) U.S. Cl. CPC B60B 11/02; B60B 33/0028; B60B 19/12; B60B 19/003

(57) ABSTRACT

A driving device for a carriage includes a motor, a speed reducer, and a first mecanum wheel and a second mecanum wheel. The speed reducer decelerates the rotation input from the motor and outputs decelerated rotation. The first and second mecanum wheels are arranged in the axial direction parallel to the rotation axis of the decelerated rotation output from the speed reducer and are rotated by the decelerated rotation output from the speed reducer. In the axial direction, the center of the speed reducer is positioned between an outer end of the first mecanum wheel opposite to the second mecanum wheel and an outer end of the second mecanum wheel opposite to the first mecanum wheel.

### CROSS-REFERENCE TO RELATED APPLICATIONS

This application is based on and claims the benefit of priority from Japanese Patent Application Serial No. 2017-029267 (filed on Feb. 20, 2017), the contents of which are hereby incorporated by reference in their entirety.

### TECHNICAL FIELD

The present invention relates to a driving device for a carriage.

### BACKGROUND

Mecanum wheels are known as traveling wheels. A mecanum wheel includes a wheel body and a plurality of rollers rotatably mounted on the outer periphery of the wheel body. Each of the rollers is supported on the wheel body so as to be rotatable around a rotation axis oblique to the rotation axis of the wheel body. A mecanum wheel having such a distinctive structure can be used as a traveling wheel of a carriage, so as to fabricate a carriage that can move in directions other than the font-rear direction of a carriage body.

However, because of the complex construction and movement, a mecanum wheel is subjected to loads in a complex manner. Therefore, in view of the load bearing capacity, it has been considered difficult in designing to use a plurality of mecanum wheels combinedly as one traveling wheel. As a result, carriages including a traveling wheel having a plurality of mecanum wheels combined together are not used widely.

### SUMMARY

The present invention addresses the above problem, and one object thereof is to provide a driving device for a carriage including a plurality of mecanum wheels. A driving device for a carriage according to the present invention comprises: a motor; a speed reducer that decelerates rotation input from the motor and outputs decelerated rotation; and a first mecanum wheel and a second mecanum wheel arranged in an axial direction parallel to a rotation axis of the decelerated rotation output from the speed reducer, the first mecanum wheel and the second mecanum wheel being rotated by the decelerated rotation output from the speed reducer, wherein, in the axial direction, a center of the speed reducer is positioned between an outer end of the first mecanum wheel opposite to the second mecanum wheel and an outer end of the second mecanum wheel opposite to the first mecanum wheel.

It is also possible that at least a part of the speed reducer is disposed inside at least one of the first mecanum wheel and the second mecanum wheel in radial directions perpendicular to the axial direction.

It is also possible that the whole speed reducer is positioned between the outer end of the first mecanum wheel and the outer end of the second mecanum wheel in the axial direction.

It is also possible that the speed reducer includes a speed reducing unit that receives power from the motor, a carrier that supports the speed reducing unit, a case rotatable relative to the carrier, and a bearing disposed between the carrier and the case, each of the first and second mecanum wheels includes a wheel body and a plurality of rollers, the wheel body being fixed on the case or the carrier, the plurality of rollers being supported on the wheel body so as to be rotatable around a rotation axis oblique to a rotation axis of the wheel body, and centers of the plurality of rollers are aligned with the bearing of the speed reducer in the axial direction.

According to the present invention, a driving device for a carriage including a plurality of mecanum wheels can be provided with a sufficient strength.

### BRIEF DESCRIPTION OF THE DRAWINGS

FIG. 1 is a front view of a driving device for a carriage, according to an embodiment of the present invention.

FIG. 2 is a sectional view of the driving device shown in FIG. 1 along the rotation axis thereof.

FIG. 3, which corresponds to FIG. 2, illustrates a first variation of the driving device.

FIG. 4, which corresponds to FIG. 2, illustrates a second variation of the driving device.

FIG. 5, which corresponds to FIG. 2, illustrates a third variation of the driving device.

FIG. 6, which corresponds to FIG. 2, illustrates a fourth variation of the driving device.

FIG. 7, which corresponds to FIG. 2, illustrates a fifth variation of the driving device.

FIG. 8, which corresponds to FIG. 2, illustrates a sixth variation of the driving device.

FIG. 9, which corresponds to FIG. 2, illustrates a seventh variation of the driving device.

FIG. 10, which corresponds to FIG. 2, illustrates an eighth variation of the driving device.

FIG. 11, which corresponds to FIG. 2, illustrates a ninth variation of the driving device.

### DESCRIPTION OF THE PREFERRED EMBODIMENTS

An embodiment of the present invention will now be described with reference to the attached drawings. The accompanying drawings are simplified and the elements in the drawings are not necessarily drawn to scale, and the dimensional ratio between the elements and shapes of the elements may be different from the actual ones. However, from such simplified drawings, the embodiments described below and other embodiments of the present invention would be sufficiently understood by those skilled in the art.

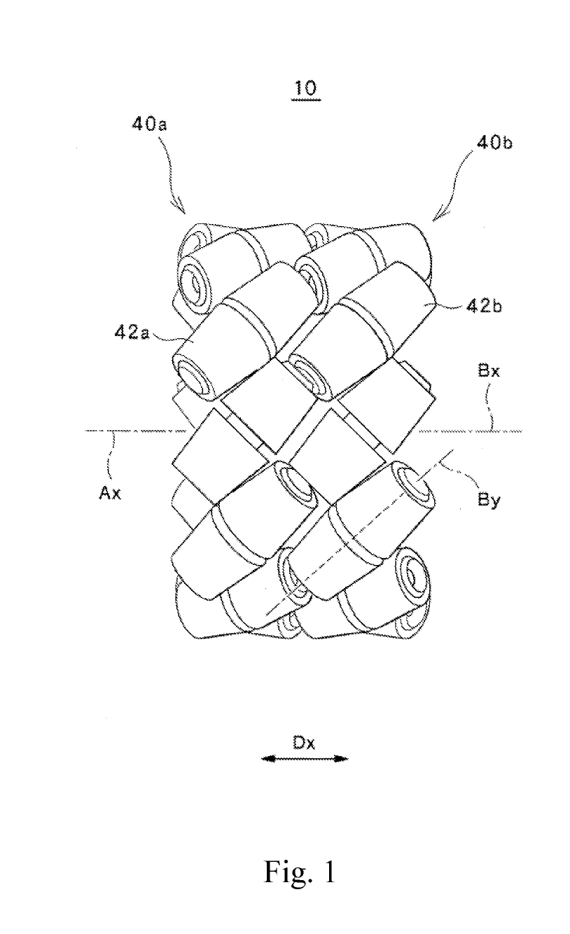

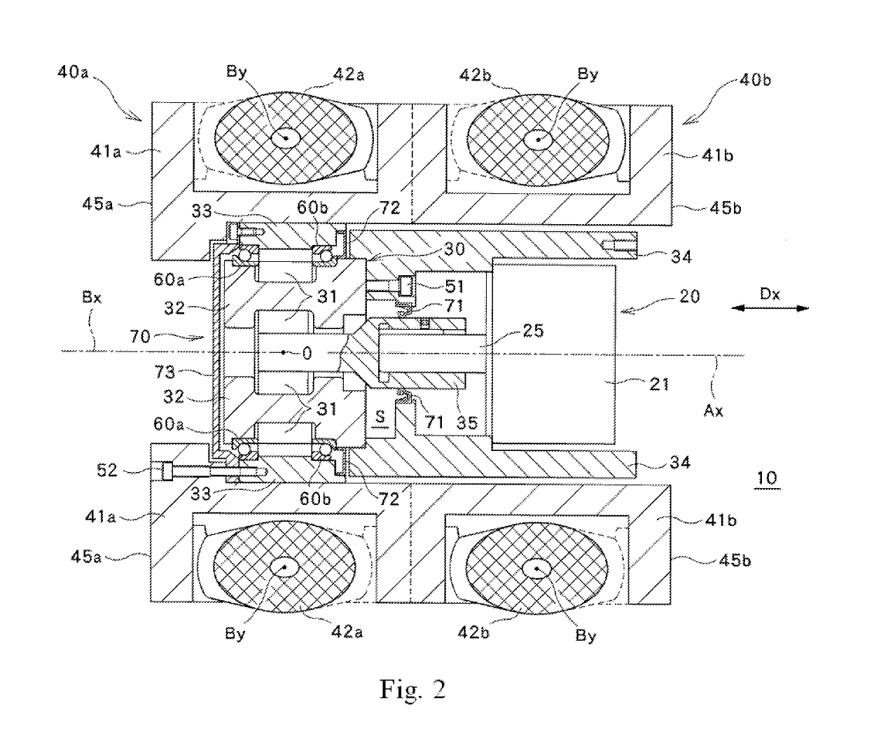

FIG. 1 is a front view of a driving device for a carriage, according to an embodiment of the present invention. FIG. 2 is a sectional view of mecanum wheels shown in FIG. 1 along the rotation axis thereof.

As shown in FIG. 1 and FIG. 2, the driving device 10 includes a motor 20, a speed reducer 30, a first mecanum wheel 40a, and a second mecanum wheel 40b. The speed reducer 30 decelerates the power (i.e., rotation) input from the motor 20 and outputs the decelerated power. The first mecanum wheel 40a and the second mecanum wheel 40b are rotated by the output from the speed reducer 30.

The speed reducer 30 will now be described in more detail with reference to FIG. 2. The speed reducer 30 includes a speed reducing unit 31, a carrier 32, and a case 33. The speed reducing unit 31 receives the power (rotation) from the motor 20. The carrier 32 supports the speed reducing unit 31. The case 33 is capable of moving relative to the carrier 32. The speed reducer 30 includes a base 34 that supports the motor 20.

The case 33 and the base 34 have a substantially cylindrical shape and extend in the direction of the rotation axis Ax of the motor 20. A body 21 of the motor 20 is mounted on one end of the base 34 via a fastening member (not shown). The motor 20 and the base 34 are fixed on a carriage body (not shown).

Inside the case 33 and the base 34 in the radial directions from the rotation axis Ax, there is provided an input shaft 35 that extends in the direction of the rotation axis Ax. Further, inside the case 33 in the radial directions from the rotation axis Ax, there are provided the speed reducing unit 31 and the carrier 32. One end of the carrier 32 is fixed on the other end of the base 34 via a fastening member 51 such as a bolt. The carrier 32 supports the speed reducing unit 31 operatively.

The input shaft 35 serves as an input gear that inputs power from the motor 20 to the speed reducing unit 31. More specifically, one end of the input shaft 35 is connected to an output shaft 25 of the motor 20. This enables the input shaft 35 to rotate around the rotation axis Ax integrally with the output shaft 25 of the motor 20. Thus, the power (rotation) output from the motor 20 is transmitted to the input shaft 35. The input shaft 35 inputs, at the other end thereof, the power from the motor 20 to the speed reducing unit 31.

The body 21 and the output shaft 25 of the motor 20 are removably mounted on the base 34 and the input shaft 35, respectively. Therefore, the motor 20 can be replaced when necessary.

The speed reducing unit 31 decelerates power (rotation) that is input from the motor 20 via the input shaft 35 and transmits the power with an increased torque to the carrier 32 or the case 33. In the example shown in FIG. 2, the carrier 32 is fixed on the base 34, and therefore, the speed reducing unit 31 transmits the power to the case 33.

In the example shown in FIG. 2, the speed reducer 30 is configured as an eccentric oscillating speed reducer, and the speed reducing unit 31 constitutes an eccentric oscillating gear. The speed reducing unit 31 is supported by the carrier 32 so as to be capable of oscillating eccentrically. An eccentric oscillating speed reducer typically has a small backlash that makes it possible to reduce malfunctions of the whole driving device 10. The speed reducer 30 is not limited to an eccentric oscillating speed reducer but may be other types of speed reducers. For example, the speed reducer 30 may be a planetary gear speed reducer or may be constituted by a speed reducing structure in which a planetary gear speed reducer and an eccentric oscillating speed reducer are combined together. Alternatively, the speed reducer 30 may be constituted by other desired types of speed reducing structures. When the speed reducer 30 is a planetary gear speed reducer, the speed reducing unit 31 constitutes a planetary gear and is rotatably supported by the carrier 32.

The case 33 is connected to the carrier 32 via a pair of bearings 60a, 60b disposed between the case 33 and the carrier 32, so as to be rotatable relative to the carrier 32. In the example shown in FIG. 2, the speed reducing unit 31 is supported by the carrier 32 fixed stationary, and therefore, the case 33 rotates around the rotation axis Ax at a reduced rotation speed in accordance with the operation of the speed reducing unit 31. The case 33 is also restrained by the bearings 60a, 60b from moving in the direction of the rotation axis Ax relative to the carrier 32.

The bearings 60a, 60b also withstand the loads imparted to the carrier 32 and the case 33. The bearings 60a, 60b are angular ball bearings, for example, but are not limited to angular ball bearings and may be other types of bearings such as cylindrical roller bearings.

When the carriage includes a mecanum wheel, a thrust load and a radial load may be imparted to the carrier 32 and the case 33 from the mecanum wheel. The thrust direction mentioned herein refers to the direction in which the rotation axis Ax extends. The radial direction mentioned herein refers to the radial directions from the rotation axis Ax.

When the bearings 60a, 60b are angular ball bearings, the bearings 60a, 60b can receive both the thrust load and the radial load between the carrier 32 and the case 33. When the bearings 60a, 60b are cylindrical roller bearings, or in more particular, cylindrical roller bearings having rolling elements that are rotatable around an axis parallel to the rotation axis Bx (described later) of the mecanum wheels 40a, 40b, the bearings 60a, 60b can receive at least the radial load between the carrier 32 and the case 33. Since the bearings 60a, 60b thus configured are disposed between the carrier 32 and the case, the thrust load and the radial load are entirely or partially prevented from being transmitted to components of the speed reducer 30 such as the speed reducing unit 31. As a result, the life span of the speed reducer 30 can be elongated.

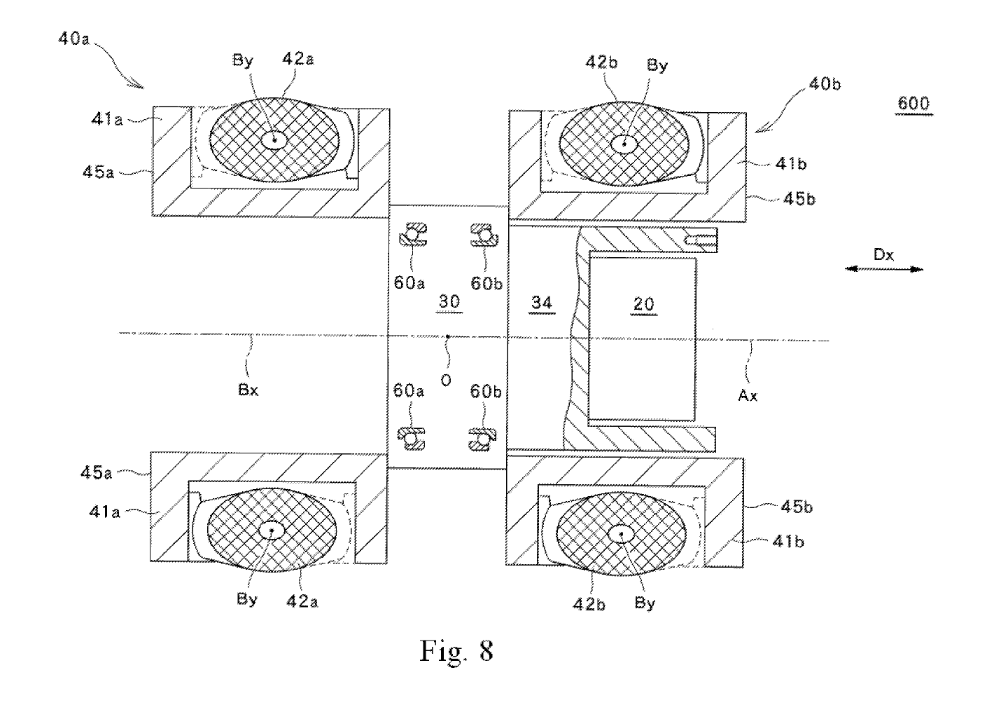

In the example shown in FIG. 2, at least a part of the speed reducer 30 is disposed inside the mecanum wheels 40a, 40b, and therefore, the distance between the mecanum wheels 40a, 40b and the speed reducer 30 along the axial direction Dx is small. As a result, the components of the speed reducer 30 are subjected to a small thrust load and a large radial load. In this arrangement, the bearings 60a, 60b may be constituted by either angular ball bearings or cylindrical roller bearings to operate suitably. By contrast, in the examples shown in FIGS. 8 to 11, the speed reducer 30 is disposed outside the mecanum wheels 40a, 40b, and therefore, the distance between the mecanum wheels 40a, 40b and the speed reducer 30 along the axial direction Dx is large. In this arrangement, the components of the speed reducer 30 are subjected to a large thrust load, and therefore, angular ball bearings are suitable.

In the example shown in FIG. 2, the internal space S surrounded by the base 34, the case 33, and the carrier 32 is sealed by a seal portion 70. The seal portion 70 in the embodiment includes a first seal element 71 that seals between the base 34 and the input shaft 35, a second seal element 72 that seals between the case 33 and the carrier 32, and a third seal element 73 that seals the other end of the case 33. The speed reducing unit 31 and the bearings 60a, 60b are disposed in the internal space S sealed and closed by the seal portion 70.

Next, the first mecanum wheel and the second mecanum wheel will be described.

As shown in FIG. 1 and FIG. 2, the first mecanum wheel 40a and the second mecanum wheel 40b are arranged in the axial direction Dx that is parallel to the rotation axial Ax of the rotation output from the speed reducer 30. In the example shown in FIG. 1 and FIG. 2, the first mecanum wheel 40a and the second mecanum wheel 40b are arranged so as to have a common rotation axis Bx.

As shown in FIG. 1, the first mecanum wheel 40a and the second mecanum wheel 40b include wheel bodies 41a, 41b and a plurality of barrel-shaped rollers 42a, 42b rotatably mounted on the periphery of the wheel bodies 41a, 41b. The rollers 42a, 42b are supported on the wheel bodies 41a, 41b so as to be rotatable around a rotation axis By oblique to the rotation axis Bx of the wheel bodies 41a, 41b. The rotation axis By of the rollers 42a, 42b extends at an angle of about 45° with respect to the rotation axis Bx. In the example shown in FIG. 2, the wheel body 41a of the first mecanum wheel 40a and the wheel body 41b of the second mecanum wheel 40b are integrated. These mecanum wheels 40a, 40b are fixed on the speed reducer 30 such that the rotation axis Bx corresponds to the rotation axis Ax.

Next, with reference to FIG. 2, a detailed description is given of how the first mecanum wheel 40a and the second mecanum wheel 40b are positionally related to the speed reducer 30 and the motor 20.

In the axial direction Dx in which the mecanum wheels 40a, 40b are arranged, the center of the speed reducer 30 is positioned between an outer end 45a of the first mecanum wheel 40a opposite to the second mecanum wheel 40b and an outer end 45b of the second mecanum wheel 40b opposite to the first mecanum wheel 40a. This arrangement of the speed reducer 30 reduces the distance from the center O of the speed reducer 30 to the first mecanum wheel 40a and the second mecanum wheel 40b along the axial direction Dx. Since this distance is small, the force imparted from the first mecanum wheel 40a and the second mecanum wheel 40b to the speed reducer 30 is applied more evenly to one side and the other side of the speed reducer 30 in the axial direction Dx, in particular to one and the other of the bearings 60a, 60b. As a result, the life span of the speed reducer 30 can be elongated. In addition, it can be prevented that the rotation axis Bx is oblique to the grounding surfaces of the mecanum wheels 40a, 40b and only one of the mecanum wheels 40a, 40b wears. Further, since the force is evenly applied from the mecanum wheels 40a, 40b to the speed reducer 30, the moment of force applied to the speed reducer 30 is small. As a result, it is possible to reduce the dimensions of the fastening member 52 for fixing the mecanum wheels 40a, 40b on the speed reducer 30.

Further, in the example shown in FIG. 2, at least a part of the speed reducer 30 is disposed inside at least one of the first mecanum wheel 40a and the second mecanum wheel 40b in the radial directions perpendicular to the axial direction Dx. FIG. 2 shows that the speed reducer 30 is disposed partially inside the first mecanum wheel 40a. In other words, at least a part of the speed reducer 30 is disposed in a region overlapping with at least one of the first mecanum wheel 40a and the second mecanum wheel 40b in the axial direction Dx.

In the example shown in FIG. 2, the case 33 of the speed reducer 30 is press-fitted into the mecanum wheels 40a, 40b. The wheel bodies 41a, 41b of the mecanum wheels 40a, 40b are fixed on the case 33 via a fastening member 52 such as a bolt, and the wheel bodies 41a, 41b are also supported at the inner peripheries thereof by the case 33. Naturally, the case 33 of the speed reducer 30 may be disposed inside at least one of the first mecanum wheel 40a and the second mecanum wheel 40b by a method other than press-fitting such as loose fitting. In the case where the speed reducing unit 31 rotates the carrier 32, the wheel bodies 41a, 41b may be fixed on the carrier 32.

Thus, since at least a part of the speed reducer 30 is disposed inside at least one of the first mecanum wheel 40a and the second mecanum wheel 40b, it is possible to reduce the dimension of the driving device 10 in the direction of the rotation axis Bx. Since the distance from the center O of the speed reducer 30 to the first mecanum wheel 40a and the second mecanum wheel 40b is small, the force imparted from the mecanum wheels 40a, 40b to the speed reducer 30 is applied more evenly to one side and the other side of the speed reducer 30, in particular to one and the other of the bearings 60a, 60b. As a result, the life span of the speed reducer 30 can be elongated. In addition, it can be prevented that the rotation axis Bx is oblique to the grounding surfaces of the mecanum wheels 40a, 40b and only one of the mecanum wheels 40a, 40b wears. Further, since the force is evenly applied from the mecanum wheels 40a, 40b to the speed reducer 30, the moment of force applied to the speed reducer 30 is small. As a result, it is possible to reduce the dimensions of the fastening member 52 for fixing the mecanum wheels 40a, 40b on the speed reducer 30.

Further, in the example shown in FIG. 2, the whole speed reducer 30 is disposed between the outer end 45a of the first mecanum wheel 40a and the outer end 45b of the second mecanum wheel 40b in the axial direction Dx. This arrangement further reduces the dimension of the driving device 10 in the axial direction. In addition, the force from the mecanum wheels 40a, 40b is applied to the speed reducer 30 more evenly in the axial direction Dx. As a result, the life span of the speed reducer 30 can be furthermore elongated. In addition, it can be prevented more effectively that only one of the mecanum wheels 40a, 40b wears. It is also possible to further reduce the dimensions of the fastening member 52.

Further, in the example shown in FIG. 2, the motor 20 is accommodated inside the first mecanum wheel 40a and the second mecanum wheel 40b. This arrangement further reduces the dimension of the driving device 10 in the axial direction.

The driving device 10 thus configured is mounted on a carriage body (not shown) to construct a carriage. It should be noted that the driving device 10 is applicable to all kinds of carriages in which power from the motor 20 is transmitted to the wheels 40a, 40b via the speed reducer 30. For example, the driving device 10 of the invention can be applied not only to carriages that require assistance by an operator during traveling but also to carriages that do not require assistance by an operator during traveling (i.e., an unmanned conveyance vehicle) such as AGVs (Automatic Guided Vehicles) or RGVs (Rail Guided Vehicles).

As described above, the driving device 10 for a carriage according to the first embodiment includes a motor 20, a speed reducer 30, and a first mecanum wheel 40a and a second mecanum wheel 40b. The speed reducer 30 decelerates the rotation input from the motor 20 and outputs the decelerated rotation. The first and second mecanum wheels 40a, 40b are arranged in the axial direction Dx parallel to the rotation axis Ax of the rotation output from the speed reducer 30 and are rotated by the output from the speed reducer 30. In addition, in the axial direction Dx, the center O of the speed reducer 30 is positioned between an outer end 45a of the first mecanum wheel 40a opposite to the second mecanum wheel 40b and an outer end 45b of the second mecanum wheel 40b opposite to the first mecanum wheel 40a.

The driving device 10 thus configured has a small dimension in the axial direction Dx. Further, a user of the driving device 10 is free from complex connection work between the mecanum wheels 40a, 40b and the speed reducer 30 in consideration of complex load application to the mecanum wheels 40a, 40b. Also, an engineer who designs the driving device 10 can design the speed reducer 30 or the whole driving device 10 in consideration of the dimensions of the mecanum wheels 40a, 40b and the size and direction of the load imparted to the mecanum wheels 40a, 40b. More specifically, since the center O of the speed reducer 30 is positioned between the outer ends 45a, 45b of the mecanum wheels 40a, 40b, the force from the mecanum wheels 40a, 40b are evenly applied to one side and the other side of the speed reducer 30 in the axial direction Dx. As a result, the life span of the speed reducer 30 can be elongated. In addition, it can be prevented that the rotation axis Bx is oblique to the grounding surfaces of the mecanum wheels 40a, 40b and only one of the mecanum wheels 40a, 40b wears. Further, since the force from the mecanum wheels 40a, 40b is more evenly applied to the speed reducer 30, the moment of force applied to the speed reducer 30 is further reduced. As a result, it is possible to reduce the dimensions of the fastening member 52 for fixing the mecanum wheels 40a, 40b on the speed reducer 30.

More specifically, at least a part of the speed reducer 30 is disposed inside at least one of the first mecanum wheel 40a and the second mecanum wheel 40b in the radial directions perpendicular to the axial direction Dx. This arrangement reduces the dimension of the driving device 10 in the axial direction. In addition, the force from the mecanum wheels 40a, 40b is applied to the speed reducer 30 more evenly in the axial direction Dx. As a result, the life span of the speed reducer 30 can be elongated. In addition, it can be prevented that only one of the mecanum wheels 40a, 40b wears. It is also possible to reduce the dimensions of the fastening member 52 for fixing the mecanum wheels 40a, 40b on the speed reducer 30.

More specifically, the whole speed reducer 30 is disposed between the outer end 45a of the first mecanum wheel 40a and the outer end 45b of the second mecanum wheel 40b in the axial direction Dx. This arrangement further reduces the dimension of the driving device 10 in the axial direction Dx. In addition, the force from the mecanum wheels 40a, 40b is applied to the speed reducer 30 more evenly in the axial direction Dx. As a result, the life span of the speed reducer 30 can be furthermore elongated. In addition, it can be prevented more effectively that only one of the mecanum wheels 40a, 40b wears. It is also possible to reduce the dimensions of the fastening member 52 for fixing the mecanum wheels 40a, 40b on the speed reducer 30.

Variations

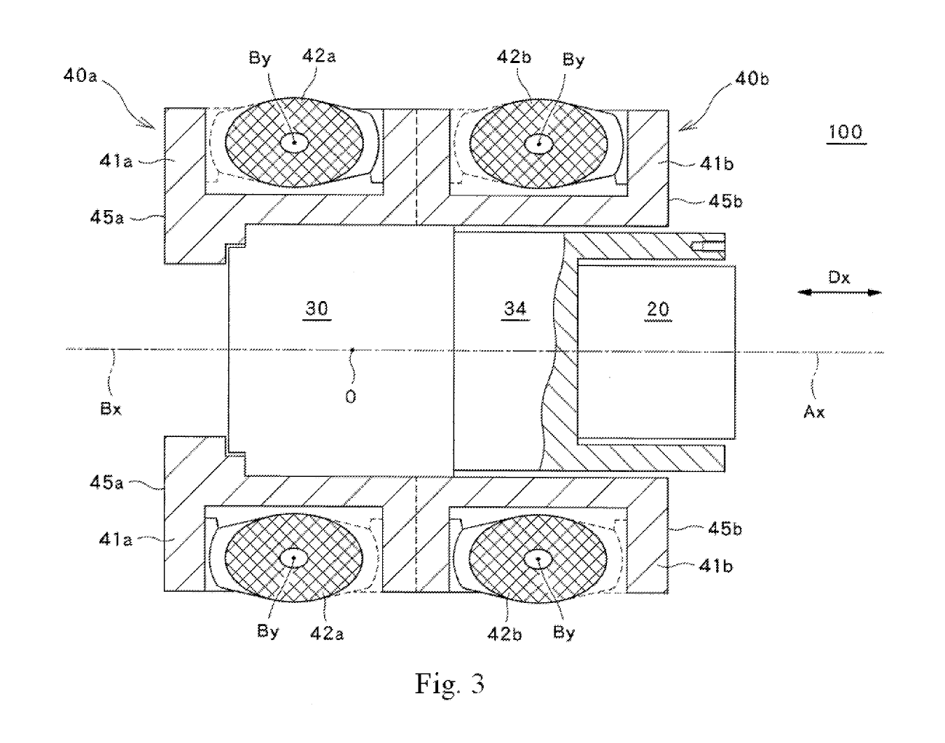

Next, variations of the driving device according the embodiment will now be described with reference to FIGS. 3 to 11. FIGS. 3 to 11, which correspond to FIG. 2, are sectional views of a driving device according to the variations, omitting components of the speed reducer and the motor but showing only the bearings of the speed reducer as necessary. In the variations shown in FIGS. 3 to 11, the same elements as in the embodiment are denoted by the same reference numerals and detailed descriptions thereof will be omitted. Furthermore, when it is obvious that the advantages obtained in the embodiment can also be obtained in the variations shown in FIGS. 3 to 11, the description of the advantages may be omitted.

First Variation

First, a driving device according to a first variation will be described with reference to FIG. 3. The driving device 100 shown in FIG. 3 is different from the driving device 10 shown in FIG. 2 in that a part of the motor 20 is disposed outside the first mecanum wheel 40a and the second mecanum wheel 40b. In other respects, this variation is configured in substantially the same manner as the embodiment shown in FIG. 2.

The driving device 100 shown in FIG. 3 provides the same advantages as the driving device 10 shown in FIG. 2.

Second Variation

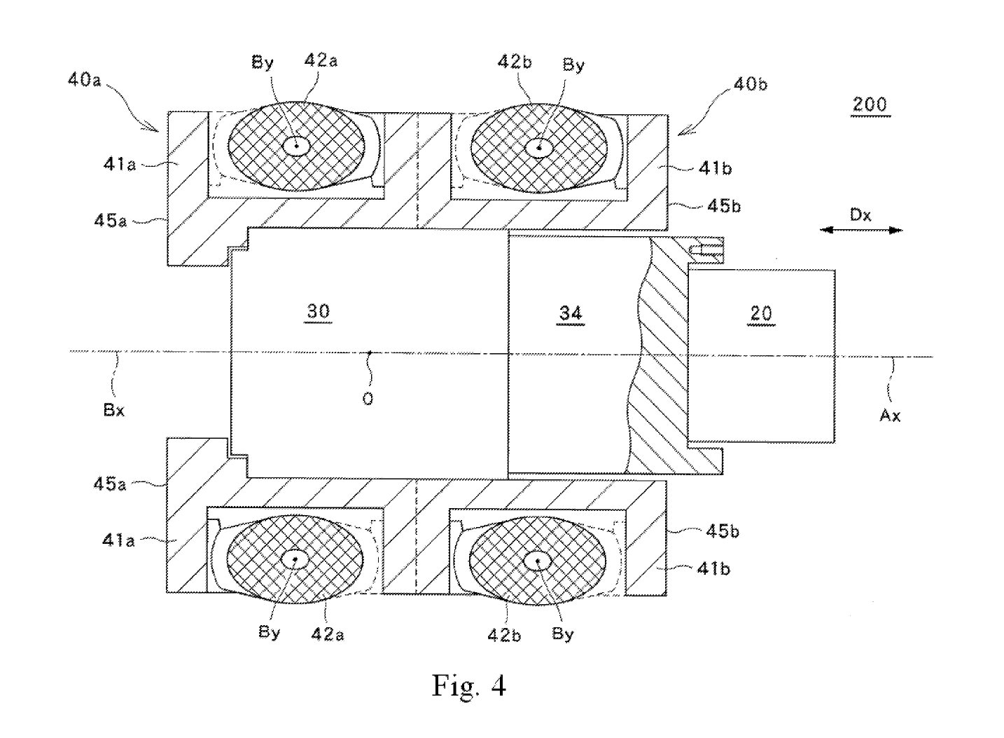

Next, a driving device according to a second variation will be described with reference to FIG. 4. The driving device 200 shown in FIG. 4 is different from the driving device 10 shown in FIG. 2 in that the whole motor 20 is disposed outside the first mecanum wheel 40a and the second mecanum wheel 40b. In other respects, this variation is configured in substantially the same manner as the embodiment shown in FIG. 2.

The driving device 200 shown in FIG. 4 provides the same advantages as the driving device 10 shown in FIG. 2.

Third Variation

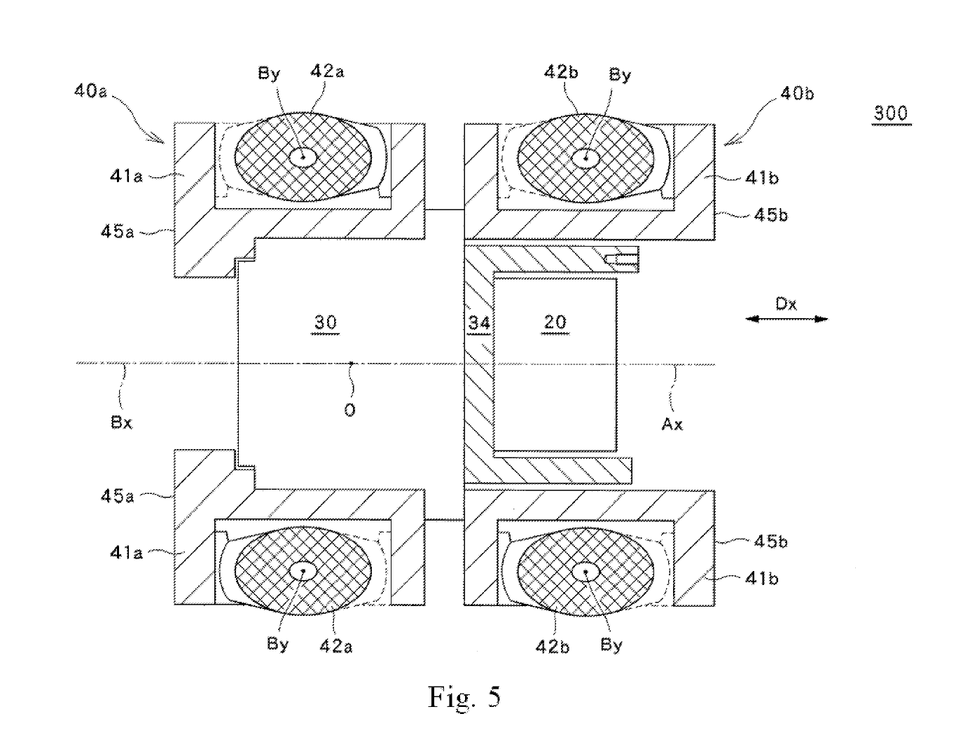

Next, a driving device according to a third variation will be described with reference to FIG. 5. The driving device 300 shown in FIG. 5 is different from the driving device 10 shown in FIG. 2 in that the wheel bodies 41a, 41b of the first mecanum wheel 40a and the second mecanum wheel 40b are not integrated together, and a part of the speed reducer 30 is disposed between the first mecanum wheel 40a and the second mecanum wheel 40b. In other respects, this variation is configured in substantially the same manner as the embodiment shown in FIG. 2.

The driving device 300 shown in FIG. 5 provides the same advantages as the driving device 10 shown in FIG. 2.

Fourth Variation

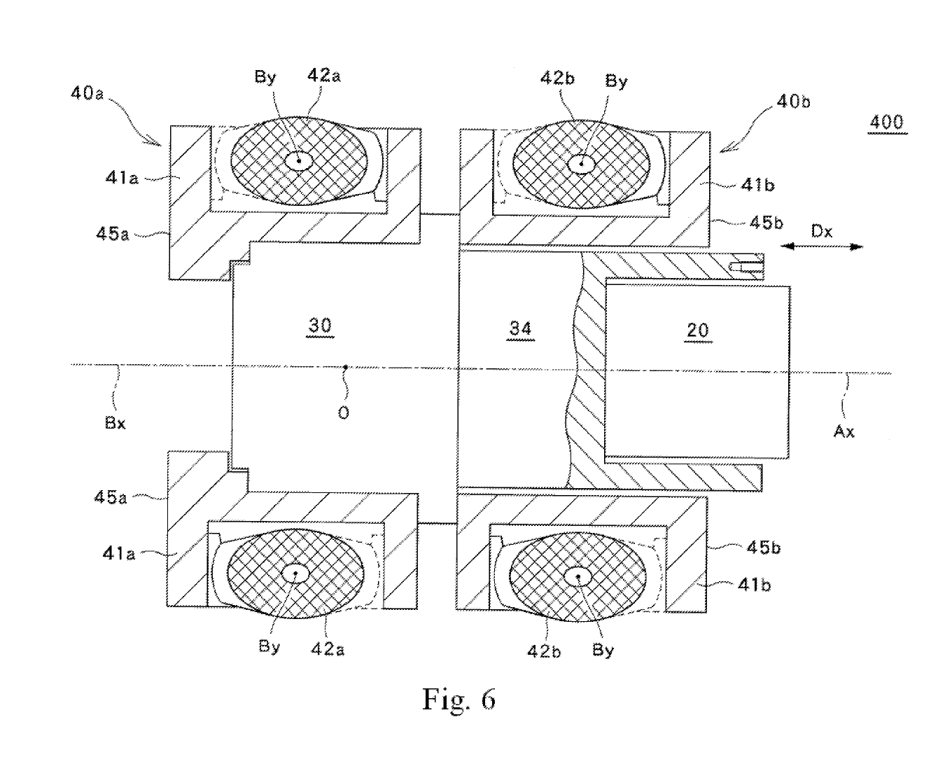

Next, a driving device according to a fourth variation will be described with reference to FIG. 6. The driving device 400 shown in FIG. 6 is different from the driving device 300 shown in FIG. 5 in that a part of the motor 20 is disposed outside the first mecanum wheel 40a and the second mecanum wheel 40b. In other respects, this variation is configured in substantially the same manner as the variation shown in FIG. 5.

The driving device 400 shown in FIG. 6 provides the same advantages as the driving device 10 shown in FIG. 2.

Fifth Variation

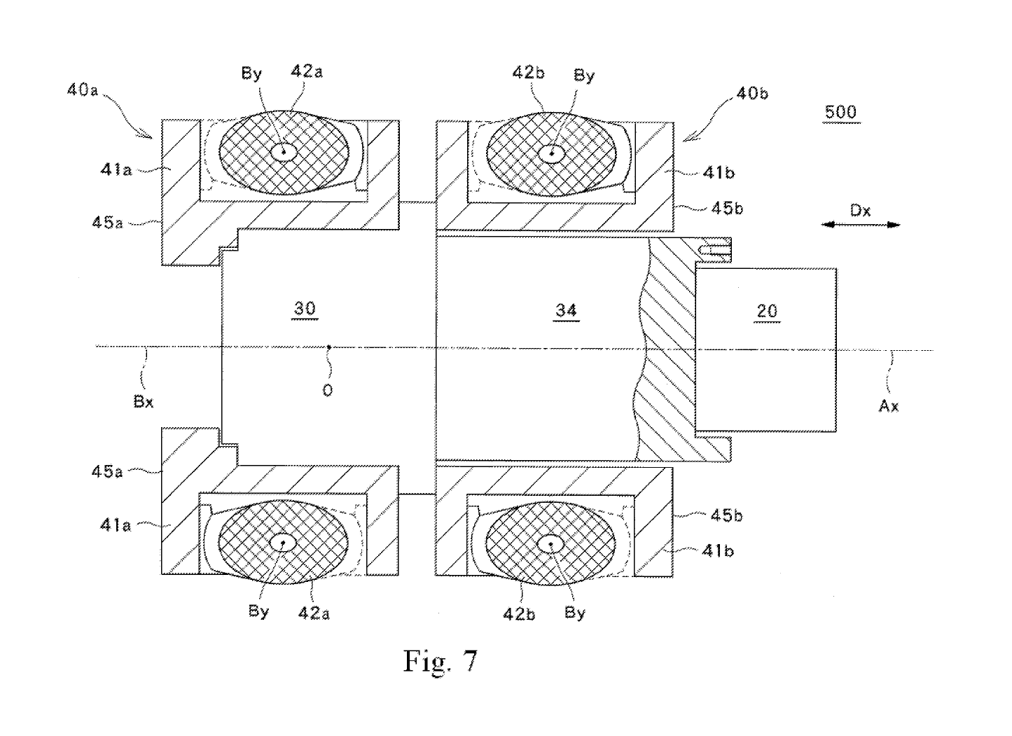

Next, a driving device according to a fifth variation will be described with reference to FIG. 7. The driving device 500 shown in FIG. 7 is different from the driving device 300 shown in FIG. 5 in that the whole motor 20 is disposed outside the first mecanum wheel 40a and the second mecanum wheel 40b. In other respects, this variation is configured in substantially the same manner as the variation shown in FIG. 5.

The driving device 500 shown in FIG. 7 provides the same advantages as the driving device 10 shown in FIG. 2.

Sixth Variation

Next, a driving device according to a sixth variation will be described with reference to FIG. 8. The driving device 600 shown in FIG. 8 is different from the driving device 300 shown in FIG. 5 in that the whole speed reducer 30 is disposed between the first mecanum wheel 40a and the second mecanum wheel 40b. In other respects, this variation is configured in substantially the same manner as the variation shown in FIG. 5.

The driving device 600 shown in FIG. 8 provides the same advantages as the driving device 10 shown in FIG. 2.

Further, in the driving device 600 shown in FIG. 8, the middle between the first mecanum wheel 40a and the second mecanum wheel 40b corresponds to the middle between the pair of bearings 60a, 60b of the speed reducer 30 in the axial direction Dx. In the example shown, the middle between the first mecanum wheel 40a and the second mecanum wheel 40b and the middle between the pair of bearings 60a, 60b of the speed reducer 30 are positioned at the center O of the speed reducer 30 in the axial direction Dx. Thus, the force from the first mecanum wheel 40a and the second mecanum wheel 40b is applied more evenly to one and the other of the bearings 60a, 60b in the axial direction Dx. As a result, the life span of the speed reducer 30 can be furthermore elongated. In addition, it can be prevented more effectively that only one of the mecanum wheels 40a, 40b wears. It is also possible to reduce the dimensions of the fastening member 52 for fixing the mecanum wheels 40a, 40b on the speed reducer 30.

Seventh Variation

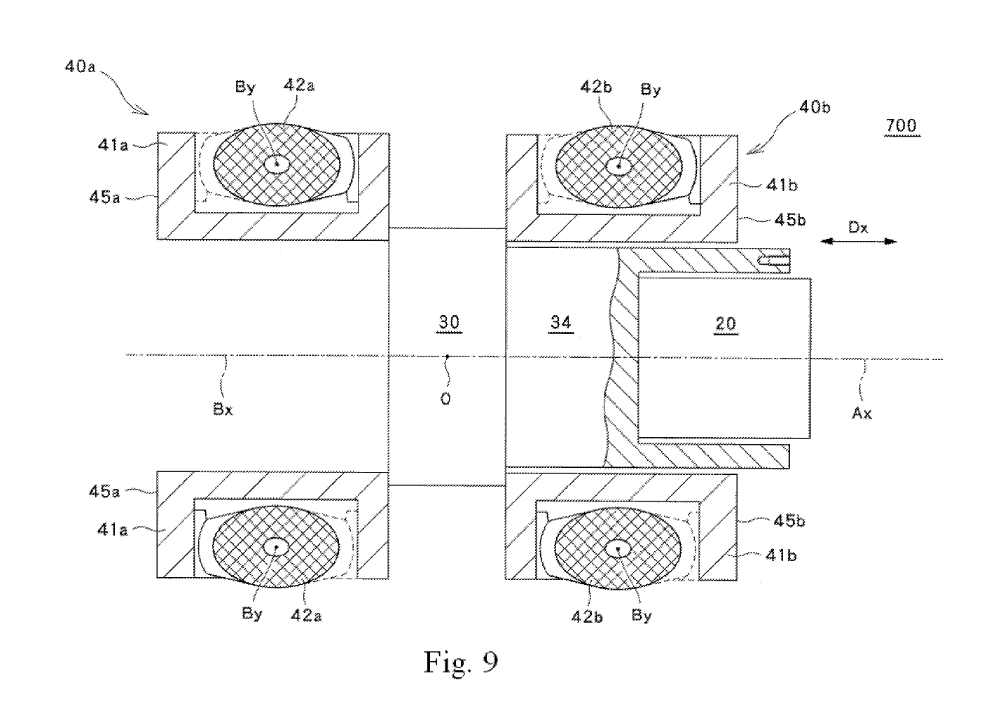

Next, a driving device according to a seventh variation will be described with reference to FIG. 9. The driving device 700 shown in FIG. 9 is different from the driving device 600 shown in FIG. 8 in that a part of the motor 20 is disposed outside the first mecanum wheel 40a and the second mecanum wheel 40b. In other respects, this variation is configured in substantially the same manner as the variation shown in FIG. 8.

The driving device 700 shown in FIG. 9 provides the same advantages as the driving device 600 shown in FIG. 8.

Eighth Variation

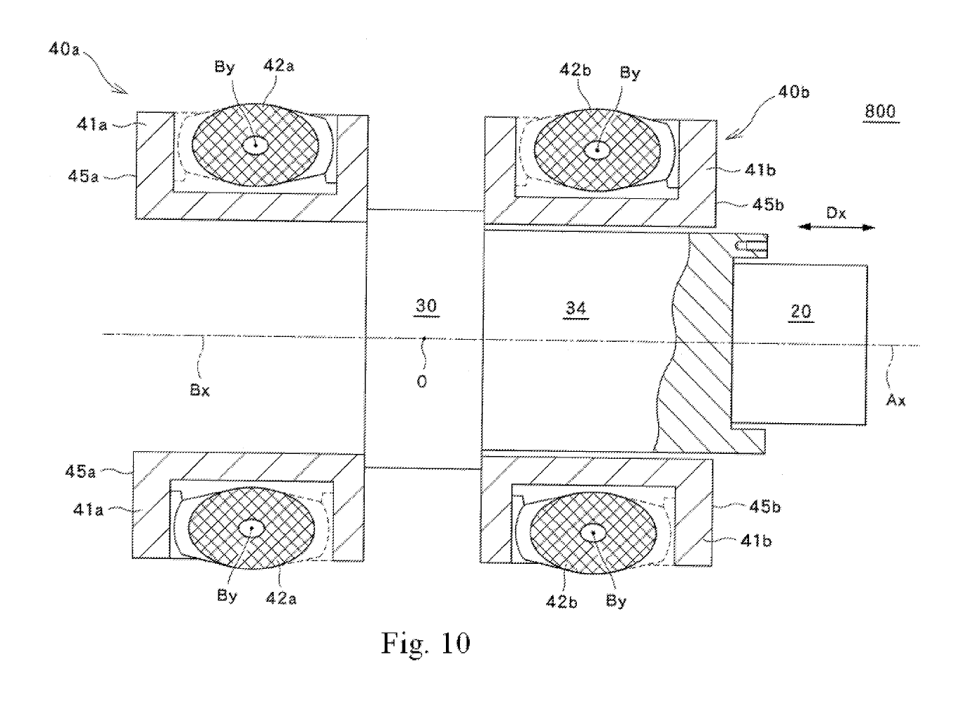

Next, a driving device according to an eighth variation will be described with reference to FIG. 10. The driving device 800 shown in FIG. 10 is different from the driving device 600 shown in FIG. 8 in that the whole motor 20 is disposed outside the first mecanum wheel 40a and the second mecanum wheel 40b. In other respects, this variation is configured in substantially the same manner as the variation shown in FIG. 8.

The driving device 800 shown in FIG. 10 provides the same advantages as the driving device 600 shown in FIG. 8.

Ninth Variation

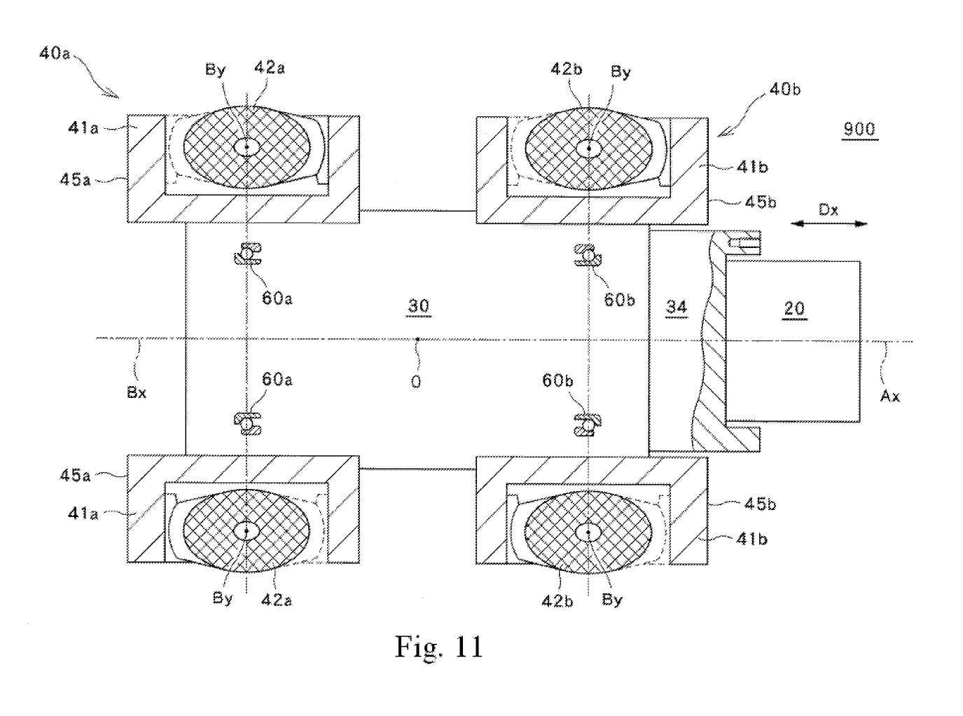

Next, a driving device according to a ninth variation will be described with reference to FIG. 11. In the driving device 900 shown in FIG. 11, the centers of the rollers 42a, 42b of the first mecanum wheel 40a and the second mecanum wheel 40b are aligned with the bearings 60a, 60b of the speed reducer 30, respectively. More specifically, the centers of the rollers 42a of the first mecanum wheel 40a are aligned with the bearing 60a of the speed reducer 30 in the radial directions, or in other words, overlap with the bearing 60a of the speed reducer 30 in the axial direction Dx. More specifically, the centers of the rollers 42b of the second mecanum wheel 40b are aligned with the bearing 60b of the speed reducer 30 in the radial directions, or in other words, overlap with the bearing 60b of the speed reducer 30 in the axial direction Dx. Thus, the force from the first mecanum wheel 40a and the second mecanum wheel 40b is applied more evenly to one and the other of the bearings 60a, 60b in the axial direction Dx. As a result, the life span of the speed reducer 30 can be furthermore elongated. In addition, it can be prevented more effectively that only one of the mecanum wheels 40a, 40b wears. It is also possible to reduce the dimensions of the fastening member 52 for fixing the mecanum wheels 40a, 40b on the speed reducer 30.

In the example shown in FIG. 11, a part of the speed reducer 30 is positioned inside the first mecanum wheel 40a in the radial directions perpendicular to the axial direction Dx, and the other parts of the speed reducer 30 are positioned inside the second mecanum wheel 40b in the radial directions. In the axial direction Dx, the whole speed reducer 30 is positioned between an outer end 45a of the first mecanum wheel 40a opposite to the second mecanum wheel 40b and an outer end 45b of the second mecanum wheel 40b opposite to the first mecanum wheel 40a.

The driving device 900 shown in FIG. 11 provides the same advantages as the other driving devices described above.

The invention is not limited to the above-described embodiment and variations. For example, various modifications may be made to the elements of the embodiment and the variations described above. The invention also encompasses embodiments including components and/or methods other than the above-described components and/or methods. The invention also encompasses embodiments not including some elements of the above-described components and/or methods. Further, the invention produces not only the advantageous effects described above but also specific effects in accordance with specific configuration of the embodiments.

What is claimed is:

1. A driving device for a carriage, comprising:
a motor;
a speed reducer that decelerates rotation input from the motor and outputs decelerated rotation; and
a first mecanum wheel and a second mecanum wheel arranged in an axial direction parallel to a rotation axis of the decelerated rotation output from the speed reducer, the first mecanum wheel and the second mecanum wheel being rotated by the decelerated rotation output from the speed reducer,
wherein, in the axial direction, a center of the speed reducer is positioned between an outer end of the first mecanum wheel opposite to the second mecanum wheel and an outer end of the second mecanum wheel opposite to the first mecanum wheel.

2. The driving device of claim 1, wherein at least a part of the speed reducer is disposed inside at least one of the first mecanum wheel and the second mecanum wheel in radial directions perpendicular to the axial direction.

3. The driving device of claim 1, wherein the whole speed reducer is positioned between the outer end of the first mecanum wheel and the outer end of the second mecanum wheel in the axial direction.

4. The driving device of claim 1, wherein the speed reducer includes a speed reducing unit that receives power from the motor, a carrier that supports the speed reducing unit, a case rotatable relative to the carrier, and a bearing disposed between the carrier and the case,
each of the first and second mecanum wheels includes a wheel body and a plurality of rollers, the wheel body being fixed on the case or the carrier, the plurality of rollers being supported on the wheel body so as to be rotatable around a rotation axis oblique to a rotation axis of the wheel body, and
centers of the plurality of rollers are aligned with the bearing of the speed reducer in the axial direction.
